(19) United States
(12) Patent Application Publication
(10) Pub. No.: US 2004/0096628 A1
(43) Pub. Date: May 20, 2004

(54) Composite panel, preferably of plastic, and method for its production

(76) Inventors: Werner Saathoff, Bodmann-Ludwigshafen (DE); Hermann Hartl, Haiterbach (DE)

Correspondence Address: M. Robert Kestenbaum, 11011 Bermuda Dunes NE, Albuquerque, NM, 87111, US

(21) Appl. No.: 10/300,243

(22) Filed: Nov. 20, 2002

(51) Int. Cl. B32B 3/00

(52) U.S. Cl. 428/174

(57) ABSTRACT

A composite panel has a three-dimensionally deformed middle layer and at least one layer arranged on at least one side of the middle layer. The middle layer has protrusions formed on both sides of a midplane with a plurality of end surfaces arranged at least partially parallel to the midplane. The end surfaces of the protrusions form contact surfaces to receive the at least one layer. The process for the production of the composite panel, employs the steps of supplying the middle layer with protrusions arranged on both sides of the midplane to a laminating station for laminating on at least one layer and moving the composite panel out of the laminating station, and supplying the composite panel to a cooling station.

### CROSS-REFERENCES TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

The present invention relates to a composite panel consisting of a three-dimensionally deformed middle layer and layer(s) arranged on at least one side of the middle layer and to a method for its production.

### TECHNICAL FIELD

A composite panel is already known which has a middle layer with protrusions formed on one side, a smooth outer layer being laminated on both sides of the middle layer. On one side, the laminated outer layer is connected to end surfaces of the protrusions formed on one side. On the opposite side, sealed air chambers are constituted by the laminating of the outer layer to a floor of the middle layer from which the protrusions extend.

This composite panel has the disadvantage that the protrusions formed on one side extend over the whole height of the middle layer, and in particular have a small wall thickness because of the negative forming of the floor of the protrusions. Also, in the transition region from the floor to the cylindrical outer surface of the protrusions, a particularly thin wall thickness arises, due to the vacuum forming to the negative form. This leads to a weakening of the composite panel. On the opposite side of the composite panel, the conditions are exactly reversed. The outer layer forms, with the exception of the cavities formed by the protrusions, a reinforcement with the floor of the middle layer. The composite panel thereby has the disadvantage that this composite panel can sustain loads of different strengths in dependence on the position in which it is built in. Furthermore, the plastic layer laminated onto the end surfaces of the protrusions can easily tear off, since the tapered wall thicknesses of the floor of the protrusions and also of the regions of the outer surface directly adjacent thereto mostly cannot take up the loads because of the negative forming. Furthermore, this composite panel has the disadvantage that a deformation or adaptation to given geometries after heating the composite panel is possible only to a very limited degree. On the one hand, therefore, since on one side, to which the floor of the middle layer is connected to the outer layer of the plastic panel, substantially higher temperatures are required, in order to heat up the composite panel for deformation, than on the opposite side. Furthermore the regions of the outer layer which are not reinforced by the floor of the middle layer because of the outward forming of the protrusions, are too strongly heated, so that these regions of the outer layer can bulge out or break out.

Furthermore, this composite panel has the disadvantage that high residual stresses are present between the individual layers of the composite panel, because of the production process. Particularly because of the different heat uptakes on the one side against which the outer layer abuts on the floor of the middle layer, and of the opposite outer layer which is only laminated to the end faces of the protrusions, residual stresses arise due to the different length extensions, and support a distortion of the plastic panel.

From DE 295 03 254 U1, a plastic panel is furthermore known which is provided for packaging containers. This composite panel has, somewhat according to the principle of corrugated cardboard, a cavity structure with two cover sheets, one on each side. This composite panel has the disadvantage that the buckling stiffness transverse to the waveforms of the corrugated cardboard is very small and thus the use of such composite panels is very greatly restricted.

### SUMMARY OF THE INVENTION

The invention therefore has as its object to provide a composite panel which has a high intrinsic stiffness and small residual stresses, and which can be deformed to adapt to different geometries, and also which is quickly and easily produced.

This object is attained by a composite panel consisting of a three-dimensionally formed middle layer and layer(s) arranged on at least one side of the middle layer, wherein the middle layer has protrusions formed on both sides of the midplane with their end surfaces arranged at least partially parallel to the midplane, and wherein the end surfaces of the protrusions form a contact surface to receive the at least one layer.

This composite panel makes it possible for a uniform material distribution to be given for the protrusions, due to the protrusions being formed on both sides of a midplane, so that a subsequent flow of the material from the connecting sections arising between the protrusions into the formed protrusions can take place during the shaping of the middle layer to form the protrusions. In this way, the wall thickness of the floor of the protrusion and also of the outer surface, particularly in the transition region, can be markedly improved and reinforced. Furthermore, this composite panel has the advantage that the contact surface to the laminated-on layer(s) is the same on each side of the middle layer.

In particular, it is provided that at least one layer is arranged on each side of the middle layer. This composite panel thereby has a uniform intrinsic stiffness and loadability, independent of the position or direction in which it is built in. The deformability of the composite panel is markedly increased by the protrusions formed on both sides of a midplane. Thus composite panel is constituted without the inclusion of air cushions, and furthermore has the same properties on each side in relation to the contact surface between the end surface of the protrusion and the laminated layer, so that a uniform heating and subsequent deformation can take place on both sides.

According to a further embodiment of the invention, it is provided that the middle layer has positively and negatively formed protrusions which are predrawn with respect to the midplane. The production of a homogeneous and stable middle layer can thereby take place in a cost-effective manner, in which middle layer the positively and negatively shaped protrusions are of nearly equal or equal quality. The concepts positive and negative mean different directions of raising with respect to the midplane. By the predrawing which in particular takes place symmetrically of the midplane, a middle layer with protrusions is created which is quasi exclusively produced from formed protrusions according to the positive forming process.

According to a further embodiment of the invention, it is provided that the positively and negatively formed protrusions of the middle layer are constituted mutually symmetrically. Warping of the composite panel consisting of at least three layers is thereby drastically reduced to the greatest extent. The residual stresses are reduced, so that the bearing capacity and also the intrinsic stiffness of the composite panel are increased.

According to a further embodiment of the invention, it is provided that the distance from the midplane to the end surfaces of the positive and negative protrusions is made equal. The structural symmetry of the composite panel is thereby further increased. The connecting sections formed between the positively and negatively formed protrusions are situated at least partially in the midplane, which at the same time represents the neutral fiber of the composite panel. The bending stiffness of the composite panel is thereby equal, independently of the direction of building in.

Alternatively to this embodiment, it can be provided that for example the negatively formed protrusion has a quantitatively smaller height than the positively formed protrusion. Alternatively it can also be provided that the height relations of the positively and negatively formed protrusions are interchanged . Depending on the case of application, the position of the midplane between the at least two layers arranged on the middle layer can be arranged optionally.

According to a further embodiment of the invention, it is provided that the positively and negatively formed protrusions are arranged in rows and columns at regular spacings, with the positively and negatively formed protrusions alternating, as seen along a row or column. A uniform arrangement of positive and negative protrusions can thereby be given, which furthermore increases the stiffness of the panel after the lamination of the layers on both sides of the middle layer. This symmetry also simplifies the cutting of the composite panel to a given measurement. A given sectional image can be selected in dependence on the line of cut. Furthermore, the number of protrusions can be substantially increased by this arrangement, so that the connecting surface between the ends of the protrusions and the laminated-on layers is increased. Furthermore, an equal surface area for lamination of the layers is provided on the one side and the other side of the midplane.

According to a further embodiment of the invention, it is provided that the end surface of the protrusions is small in relation to the surface distance between two positively or negatively formed protrusions. In this way it is made possible for both the outer surface of the protrusions and also the floor of the protrusions to have a sufficient wall thickness after the positive and negative forming, whereby the stability of the composite panel can be increased.

According to a further embodiment of the invention, it is provided that the positively and negatively formed protrusions are arranged mutually adjacent and have a transition region, which extends in a straight line between the end faces of the positively and negatively formed protrusions. A rigid connection results between the two end faces, which in particular make possible a high force uptake, particularly in the case of a square patterning or arrangement of the protrusions.

According to a further embodiment of the invention, it is provided that connecting sections are constituted between the transition regions and provided in the region of the midplane. A symmetrical structure of the composite panel can thereby result. These connecting sections advantageously merge smoothly into the transition region and into the outer surface and the floor of the protrusions. Alternatively, it is provided, particularly in the case of a continuous production of the middle layer by a roller pair or belt pair, that the connecting sections are approximated to a plane extending in two dimensions. More or less, two separated chambers are thereby formed within the layers of the composite panel, and also make it possible to pass different media through, for example for cooling, heating, insulating or the like.

According to a further embodiment of the invention, it is provided that the protrusions are constituted with a frustroconical shape. This allows particularly smooth transitions. Furthermore a suitable air circulation between the laminated layers can also be made possible. Alternatively, there can also be provided protrusions with frustropyramidal shape, hemispherical protrusions with a flattening, polygonal protrusions with a flattening, or protrusions constituted with other geometries.

This composite panel is produced, according to the invention, by a process wherein a middle layer with protrusions arranged on both sides of the midplane is supplied to a laminating station for laminating on at least one layer, and wherein the composite panel, consisting of a middle layer and at least one layer arranged thereon, is moved out of the laminating station and is supplied to a cooling station. This process has the advantage that a composite panel can be produced that has smaller residual stresses than the panel known from the prior art. Furthermore, the lamination of the layers onto both sides of the middle layer is facilitated, since only the end surfaces of the protrusions are to be bonded to the layers.

It is provided that the layers are simultaneously mounted on both sides of the middle layer in the laminating station. The composite panels can thereby be completed in a laminating station. Furthermore, the same stresses occur on both sides of the middle layer, and are equalized by predrawing of the middle layer.

According to a further embodiment of the invention, it is provided that the production of the middle layer and the lamination of the layers onto both sides of the middle layer are performed continuously. A high throughput and high productivity can thereby be given for the production of the composite panel.

### BRIEF DESCRIPTION OF THE DRAWINGS

A preferred embodiment example of a composite panel and a method for its production are described in detail in the following description and with reference to the accompanying drawings, in which:

FIG. 1 shows a perspective view of a composite panel,

FIG. 2 shows a top view of a middle layer of the composite panel,

FIG. 3 shows a schematic sectional diagram of a middle layer along the line III-III in FIG. 2,

FIG. 4 shows a schematic sectional diagram of a middle layer along the line IV-IV in FIG. 2,

FIG. 5 shows a schematic diagram of process steps for the production of a composite panel according to the invention.

### DETAILED DESCRIPTION OF THE INVENTION

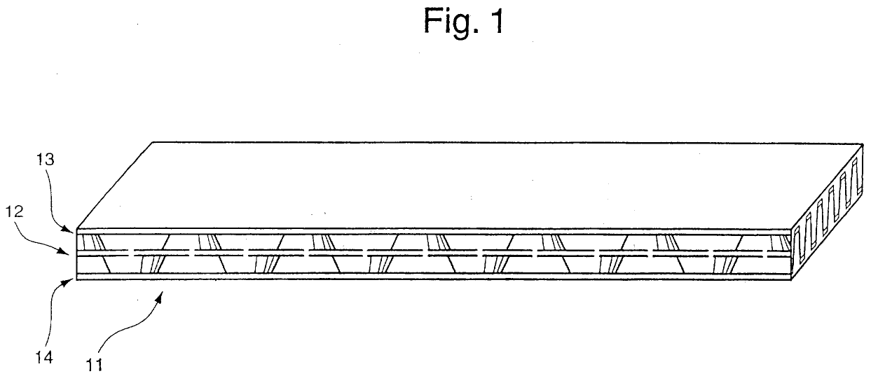

A composite panel 11 is shown in perspective in FIG. 1. This composite panel 11 has a middle layer 12 which is surrounded on each side by a layer 13 and 14. Such a composite panel 11 is for example produced completely from plastic. For example, HDPE, PE or PP, PS, ABS or the like plastics can be used. Such composite panels are used, for example, in automotive technology for floor, side and roof linings, and if necessary are laminated with additional layers. Furthermore, the composite panel can be used as cavity lining, partition or covering, for returnable packaging as a partitioned or folding box, and also for packaging for machine and device parts, and likewise as reinforcement and insertion parts, lightweight luggage, materials for the building sector, and the like. The plastic is selected in dependence on the end use. Likewise the wall thicknesses of the layers 13 and 14 and that of the middle layer 12, and also the dimensioning of the whole are selected.

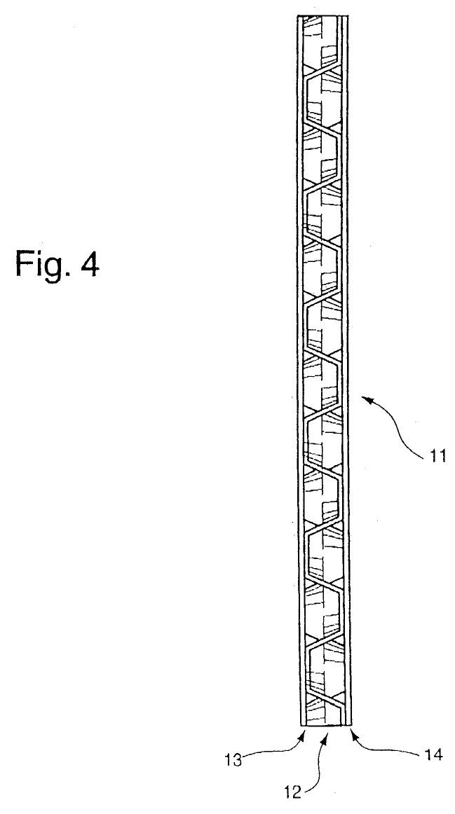

According to a further embodiment of the composite panel, it is provided to apply a middle layer and one or more layers to one of the two sides of the protrusions. The composite panel can be used for applications in which the loadability is smaller and/or the conformability is greater than are required for the composite panel according to FIGS. 1 and 4.

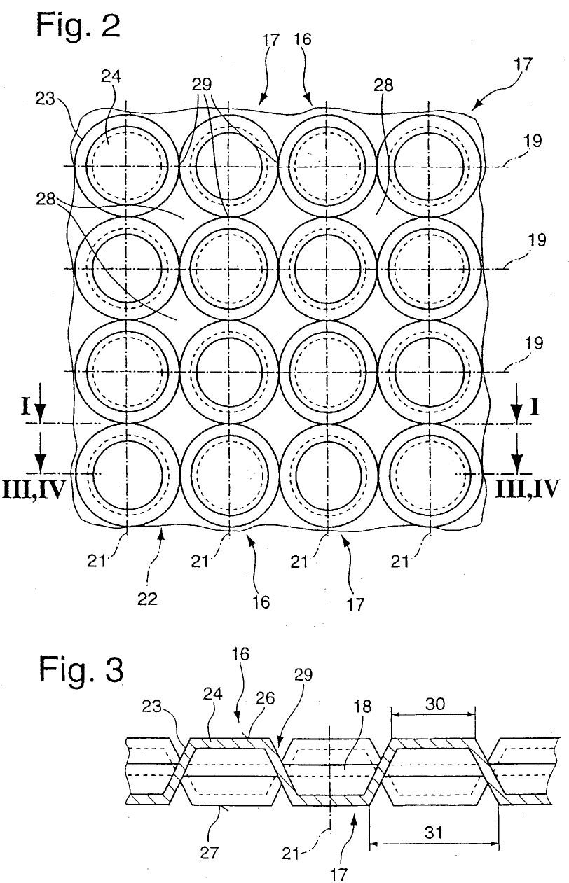

The middle layer 12 is shown in detail in FIGS. 2 and 3. The middle layer 12

has positively formed protrusions 16 and negatively formed protrusions 17, which are formed outward with respect to a midplane 18 of the middle layer 12. The positively formed protrusions 16 and negatively formed protrusions 17 are arranged in rows 19 and columns 21, the row spacing and column spacing being equal in the embodiment example. Irregular spacings can also be provided in order to attain special effects, particular in the introduction of deformations. The row spacing and also the column spacing is determined from the middle of one protrusion 16, 17 to the middle of the adjacent protrusion 17, 16. The protrusions 16, 17 are arranged alternately and mutually adjacent along the rows 19 and columns 21, so that a negatively formed protrusion 17 is between two positively formed protrusions 16, and vice versa. A raster pattern 22 results, as can be gathered in the top view of FIG. 2 and also in the sectional diagram of FIG. 3. Both the positively and the negatively formed protrusions 16, 17 have an outer surface 23 which merges into a floor 24. The outside of the floor 24 of the protrusions 16, 17 forms the end surface 26, 27 of the protrusions 16 and 17, onto which surface the layer 13, 14 is applied.

A connecting section 28 is constituted between two mutually spaced-apart positively formed protrusions 16 and negatively formed protrusions 17, which respectively lie on a straight line which runs diagonally of the rows 19 and columns 21. This connecting section 28 is preferably constituted as a three-dimensional transition to the adjacent protrusions 16, 17. In the embodiment example, the connecting section 28 is constituted partially planar and is situated in the region of the midplane 18. This connecting section 28 forms at the same time a neutral fiber of the composite panel 11, so as to create a composite panel 11 which is independent of the direction of building in. This can be seen, for example, from a sectional diagram along the line I-I in FIG. 2, shown in FIG. I as a side view over the thickness of the composite panel 11.

A transition region 29 is formed between a positively shaped protrusion 16 and a negatively shaped protrusion 17, and is constituted locally at least in a straight line from the end surface 26 of the protrusion 16 as far as the end surface 27 of the protrusion 17. Favorable force transmission properties are thereby obtained. Provided that the distance between the protrusions 16, 17 is kept greater, the transition region can also be constituted in a stepped form.

Numerous protrusions 16, 17 can be formed by means of the raster-like arrangement according to FIG. 2, the ultimate load and also the stiffness being thereby given due to the increased contact surface between the end surfaces 26, 27 of the protrusions 16, 17 and the layers 13, 14.

The protrusions 16, 17 are constituted frustroconical in the embodiment example. The diameter of the end surface 26, 27 is advantageously smaller than the surface spacing between two positively formed 16 or two negatively formed protrusions 17. The composite panel 11 according to this embodiment has, for example, a diameter 30 of an end surface of 5.5 mm and a surface distance 31, or a maximum distance between the edge regions of the mutually spaced-apart positively formed protrusions 16 or negatively formed protrusions 17, of 9 mm. A ratio between the surface distance 31 and the end surface 26, 27 of less than 1:1.5 is particularly advantageous for the embodiment of the middle layer 12. A sufficiently thick floor 24 or the protrusions 16, 17 and a sufficiently stiff outer surface 23, particularly in the transition region to the floor 24 of the protrusions 16, 17, can be constituted. Furthermore, the arrangements of the connecting sections 28 have the advantage that during the forming of the protrusions 16, 17, a sufficient subsequent flow of the materials into the protrusions 16, 17 takes place. Due to the deformation of the protrusions 16, 17 on both sides of the midplane 18, a molding-out of the protrusions 16, 17 only by half the height is required for constituting the middle layer 12, whereby furthermore an increased amount of material is made available for the positively and negatively formed protrusions, in order to constitute these stiffer.

The total thickness of the composite panel 11 is determined both by the wall thickness of the layers 13, 14 and also by the height of the protrusions 16, 17. According to the embodiment example, it is provided that the height of the positively formed protrusions and the height of the negatively formed protrusions is constituted equal, and the total height of the middle layer 12 is determined by the molding-out of the protrusions in opposite directions. The composite panel 11 can also be constituted by different materials. For example, the middle layer 12 is constituted of an impact resistant plastic and the layers 13 and 14 can be of a plastic material differing from this. In dependence on the case of application, the layers 13, 14 and the middle layer 12 can also be constituted differing from each other. It can likewise be provided that a further plate-shaped layer, which can have additional functions, is arranged between the end surfaces 26, 27 of the protrusions 16, 17 and the layers 13, 14. With different materials of the layers 13, 14, the wall thicknesses can also be made different, provided that the symmetry is maintained as regards the loadability of the composite panel. It can likewise be provided that a distortion can be introduced into the composite panel 11 by different materials of the layers 13, 14 or unequally thick layers 13, 14 with the same materials. Likewise, different thicknesses of the layers 13, 14 can be provided if, for example, a further layer, such as for example a carpet, is applied, in order to equalize the distortion of this carpet layer or the like.

The layer 13 and 14 is constituted as a planar surface on its outer side. For given cases of application, further layers can be partially or completely adhered or laminated on. For example, foam material layers or special insulating layers or separating layers, which are conductive or are resistant to given media, can be applied to the layer or themselves applied as a layer to the middle layer. Metallic, non-ferrous metallic layers can also be provided as the layer 13, 14 and also light metal layers as alloys, for example an aluminum alloy

A section is shown in FIG. 4 along the line IV-IV in FIG. 2, where in contrast to FIG. 2 the layers 13 and 14 are addition provided on the end surfaces 26, 27 of the protrusions 16, 17. The symmetrical construction of the composite panel 11 can likewise be seen from this sectional diagram, as from FIGS. 1-3. The layers 13, 14, and also the end faces 26, 27 of the protrusions 16, 17, are heated before the laminating process and are pressed together under gentle pressure, so that a bonding of the layers 13, 14 takes place. It can alternatively be provided that adhesion-supporting materials or bond-activating materials in addition are applied to the end surfaces in order to increase the bonding between the layers 13, 14 and the middle layer 12.

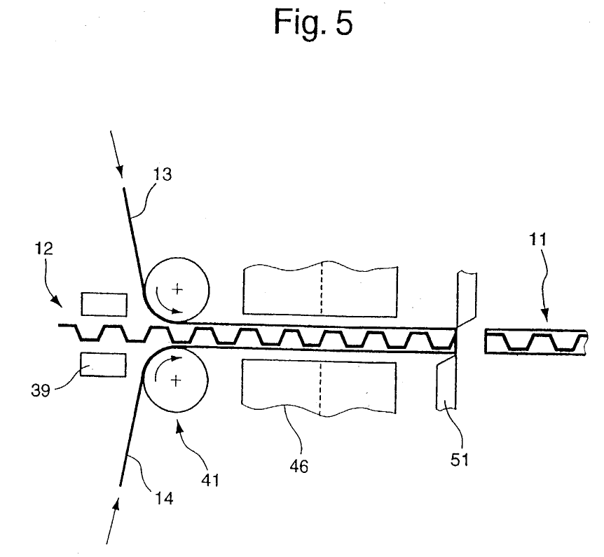

A process for the production of the composite panel 11 according to the invention is shown in FIG. 5.

The middle layer 12 is either produced separately and furnished as a rolled length or as panel material. Alternatively, the middle layer 12 can be produced by a roller pair or belt pair and a finishing path can be provided as the first station. A predrawing of the material for the production of a middle layer 12 with positively and negatively formed protrusions of like quality, particularly as regards the wall thickness, is advantageously performed by the roller pair of belt pair. The predrawn layer is sucked onto a roller or belt by a vacuum suction, in order to form the final form of the protrusions of the middle layer by vacuum deep drawing.

After the production or furnishing of the middle layer 12, this is supplied to a laminating station 41. It is provided hereby that the layers 13, 14 are supplied prefabricated, or that these are directly supplied from a preceding extruder station. Advantageously, the layers 13, 14 are simultaneously laminated to the middle layer 12. Smaller residual stresses in the composite panel 11 can thereby be attained. Before the middle layer 12 runs into the laminating station 41, at least the end surfaces 26, 27 of the protrusions 16, 17 are heated by means of a heating or radiating unit 39. The middle layer 12 is advantageously predrawn in at least the transverse direction before being supplied to the laminating station 41, so as to have small residual stresses between the layers 13 and 14 and the middle layer 12 after cooling. The middle layer 12 is supplied in a manner such that the rows 19 and columns 21 of the protrusions 16, 17 are aligned diagonally of the direction of conveying.

After the layers 13, 14 have been laminated on, the composite panel 11 is supplied to a cooling station 46. In a following cutting unit 51, the composite panels 11 are ready-made in advance to predetermined lengths. Alternatively, it can be provided that the lamination of the layers 13, 14 takes place in succession, in order to attain by predrawing in the individual intermediate stages a smaller residual stress in the composite panel 11.

We claim:

1. A composite panel, comprising a three-dimensionally deformed middle layer (12) and at least one layer (13, 14) arranged on at least one side of the middle layer (12), wherein the middle layer (12) comprises protrusions (16, 17) formed on both sides of a midplane (18) with a plurality of end surfaces (26, 27) arranged at least partially parallel to the midplane (18), and wherein the end surfaces (26, 27) of the protrusions (16, 17) form contact surfaces to receive the at least one layer (13, 14).

2. The composite panel according to claim 1, wherein the at least one layer (13, 14) is provided on each side of the middle layer (12).

3. The composite panel according to claim 1, wherein the middle layer (12) comprises predrawn positively and negatively formed protrusions (16, 17) with respect to the midplane (18).

4. The composite panel according to claim 1, wherein the positively and negatively formed protrusions (16, 17) of the middle layer (12) are arranged symmetrically of one another.

5. The composite panel according to claim 1, wherein a distance of the midplane (18) to the end surfaces (26, 27) of the positively and negatively formed protrusions (16, 17) are equal.

6. The composite panel according to claim 1, wherein the positively and negatively formed protrusions (16, 17) are arranged in rows and columns at regular spacings from one another, and the positively and negatively formed protrusions (16, 17) are provided mutually alternating along a row (19) or a column (21).

7. The composite panel according to claim 1, wherein the end surfaces (26, 27) of the protrusions (16, 17) are small in relation to a surface distance (31) between two positively and negatively formed protrusions (16, 17)

8. The composite panel according to claim 1, wherein the positively and negatively formed protrusions (16, 17) are arranged adjacently to one another and comprise transition regions (29) which extend in a straight line between an end surface (26) of the positively formed protrusion (16) and an end surface (27) of the negatively formed protrusion (17).

9. The composite panel according to claim 8, wherein connecting sections (28) are provided between the transition regions (29) and in the midplane (18).

10. The composite panel according to claim 9, wherein the connecting sections (28) are substantially planar and are arranged in or parallel to the midplane (18).

11. The composite panel according to claim 1, wherein the protrusions (16, 17) are frustro-conical, and their quantitative height, seen from the midplane (18), are equal.

12. A process for the production of a composite panel (11), comprising a middle layer (12) and layer(s) (13, 14) arranged on at least one side of the middle layer (12), in particular according to claim 1, comprising the steps of
supplying the middle layer (12) with protrusions (16, 17) arranged on both sides of the midplane (18) to a laminating station (41) for laminating on at least one layer (13, 14),
moving the composite panel (11), comprising the middle layer (12) and at least one layer (13, 14) arranged thereon out of the laminating station, and
supplying the composite panel to a cooling station (46).

13. The process according to claim 12, comprising laminating the middle layer (12) on both sides simultaneously, in the laminating station (41) with at least one layer (13, 14).

14. The process according to claim 12, comprising the step of providing the middle layer (12) and its lamination continuously in an in-line process.

15. The process according to claim 12, comprising the step of heating a plurality of end surfaces (26, 27) of the protrusions (16, 17) before lamination of the layers (13, 14) onto the middle layer (12).

16. The process according to claim 12, comprising the step of predrawing the middle layer (12) in at least one direction before lamination of the layers (13, 14).

17. The process according to claim 12, comprising the steps of producing the layers (13,14) in a chill roll process and directly supplying the layers (13,14) to the laminating station (41).

18. The process according to claim 12, comprising the steps of positively and negatively forming the protrusions (16, 17) in a row and column arrangement aligned diagonally of a transport direction and supplying the protrusions (16, 17) to the laminating station (41).

19. The process according to claim 12, comprising the step of producing the middle layer (12) by a roller pair or belt pair, and
arranging the roller pair or belt pair before the laminating station (41).
